(19) United States
(12) Patent Application Publication
(10) Pub. No.: US 2018/0138991 A1
(43) Pub. Date: May 17, 2018

(54) Method and Apparatus for Preventing Camera from Interfering with Antenna, and Electronic Device

(71) Applicant: Huawei Technologies Co., Ltd., Shenzhen, Guangdong (CN)

(72) Inventors: Sheng WANG, Wuhan (CN); Kemeng WANG, Wuhan (CN)

(21) Appl. No.: 15/568,362

(22) PCT Filed: Apr. 20, 2015
(86) PCT No.: PCT/CN2015/076969

§ 371 Date: Oct. 20, 2017

(51) Int. Cl. H04B 15/04; H04M 1/725; H01Q 1/52; H04N 5/232

(52) U.S. Cl. CPC H04B 15/04; H04M 1/72563; H04M 2250/52; H04N 5/232; H01Q 1/52

(57) ABSTRACT

A method and an apparatus for preventing a camera from interfering with an antenna, and an electronic device, where the method includes detecting whether an electronic device successfully camps on a network after a camera is started, obtaining a network resource on which the electronic device camps, and a current configuration parameter of the camera if the electronic device successfully camps on the network, determining whether an antenna is interfered by a signal generated by the camera, obtaining a configuration parameter using which the antenna is not interfered if the antenna is interfered by the signal generated by the camera, and modifying the current configuration parameter of the camera using the obtained configuration parameter using which the antenna is not interfered.

### CROSS-REFERENCE TO RELATED APPLICATION

This application is a U.S. National Stage of International Patent Application No. PCT/CN2015/076969 filed on Apr. 20, 2015, which is hereby incorporated by reference in its entire.

### TECHNICAL FIELD

The present disclosure relates to the field of communications technologies, and in particular, to a method and an apparatus for preventing a camera from interfering with an antenna, and an electronic device.

### BACKGROUND

As electronic devices trend toward being lighter and thinner, internal layouts of electronic devices become more compact. Consequently, a camera is easily close to an antenna. However, after the camera is started, a high-speed signal generated by the camera enters the antenna, and forms intermodulation interference with a signal received by the antenna, affecting antenna performance of the electronic device. Consequently, call or data service performance is degraded.

In technical solutions of other approaches, a shielding material is usually used to package a flexible printed circuit board and a base of a camera module to decrease camera impact on antenna performance.

In a process of implementing the present disclosure, the inventor finds that the other approaches have at least the following problem. A connector of a camera module still leaks some signals, and consequently antenna performance of an electronic device is affected.

### SUMMARY

To resolve a problem that a connector of a camera module leaks some signals, and consequently antenna performance of an electronic device is affected, embodiments of the present disclosure provide a method and an apparatus for preventing a camera from interfering with an antenna, and an electronic device. The technical solutions are as follows.

According to a first aspect, a method for preventing a camera from interfering with an antenna is provided, applied to an electronic device including a camera and an antenna, where the method includes detecting whether the electronic device successfully camps on a network after the camera is started, obtaining a network resource on which the electronic device camps, and a current configuration parameter of the camera if the electronic device successfully camps on the network, determining whether the antenna is interfered by a signal generated by the camera, obtaining a configuration parameter using which the antenna is not interfered if the antenna is interfered by the signal generated by the camera, and modifying the current configuration parameter of the camera using the obtained configuration parameter using which the antenna is not interfered.

In a first possible implementation manner of the first aspect, determining whether the antenna is interfered by a signal generated by the camera includes determining an interference parameter according to a preset relational database, the obtained network resource, and the obtained current configuration parameter, where the relational database stores a correspondence between each network resource and each configuration parameter and an interference parameter, and the interference parameter is used to indicate whether the antenna camping on the network resource is interfered by a signal generated by the camera that is started using the configuration parameter, and determining, according to the interference parameter, whether the antenna is interfered by the signal generated by the camera.

With reference to the first aspect or the first possible implementation manner of the first aspect, in a second possible implementation manner, obtaining a configuration parameter using which the antenna is not interfered includes determining, according to the relational database, the configuration parameter using which the antenna camping on the network resource is not interfered.

With reference to the first aspect, the first possible implementation manner of the first aspect, or the second possible implementation manner of the first aspect, in a third possible implementation manner, the method further includes maintaining the current configuration parameter unchanged if the antenna is not interfered by the signal generated by the camera.

With reference to the first aspect, the first possible implementation manner of the first aspect, the second possible implementation manner of the first aspect, or the third possible implementation manner of the first aspect, in a fourth possible implementation manner, the method further includes restoring the current configuration parameter of the camera to a default configuration parameter if the electronic device does not successfully camp on the network.

With reference to the first aspect, the first possible implementation manner of the first aspect, the second possible implementation manner of the first aspect, the third possible implementation manner of the first aspect, or the fourth possible implementation manner of the first aspect, in a fifth possible implementation manner, the network resource includes the first one, the first two, or all of a frequency band, a channel, and a bandwidth.

According to a second aspect, an apparatus for preventing a camera from interfering with an antenna is provided, applied to an electronic device including a camera and an antenna, where the apparatus includes a detection module configured to detect whether the electronic device successfully camps on a network after the camera is started, a first obtaining module configured to obtain a network resource on which the electronic device camps, and a current configuration parameter of the camera when the detection module detects that the electronic device successfully camps on the network, a determining module configured to determine whether the antenna is interfered by a signal generated by the camera, a second obtaining module configured to obtain a configuration parameter using which the antenna is not interfered when the determining module determines that the antenna is interfered by the signal generated by the camera, and a modification module configured to modify the current configuration parameter of the camera that is obtained by the first obtaining module, using the configuration parameter using which the antenna is not interfered and that is obtained by the second obtaining module.

In a first possible implementation manner of the second aspect, the determining module is further configured to determine an interference parameter according to a preset relational database, the obtained network resource, and the obtained current configuration parameter, where the relational database stores a correspondence between each network resource and each configuration parameter and an interference parameter, and the interference parameter is used to indicate whether the antenna camping on the network resource is interfered by a signal generated by the camera that is started using the configuration parameter, and determine, according to the interference parameter, whether the antenna is interfered by the signal generated by the camera.

With reference to the second aspect or the first possible implementation manner of the second aspect, in a second possible implementation manner, the second obtaining module is further configured to determine, according to the relational database, the configuration parameter using which the antenna camping on the network resource is not interfered.

With reference to the second aspect, the first possible implementation manner of the second aspect, or the second possible implementation manner of the second aspect, in a third possible implementation manner, the modification module is further configured to maintain the current configuration parameter unchanged when the determining module determines that the antenna is not interfered by the signal generated by the camera.

With reference to the second aspect, the first possible implementation manner of the second aspect, the second possible implementation manner of the second aspect, or the third possible implementation manner of the second aspect, in a fourth possible implementation manner, the modification module is further configured to restore the current configuration parameter of the camera to a default configuration parameter when the detection module detects that the electronic device does not successfully camp on the network.

With reference to the second aspect, the first possible implementation manner of the second aspect, the second possible implementation manner of the second aspect, the third possible implementation manner of the second aspect, or the fourth possible implementation manner of the second aspect, in a fifth possible implementation manner, the network resource includes the first one, the first two, or all of a frequency band, a channel, and a bandwidth.

According to a third aspect, an electronic device is provided, where the electronic device includes a camera and an antenna, and the electronic device further includes a processor, where the processor is configured to detect whether the electronic device successfully camps on a network after the camera is started, obtain a network resource on which the electronic device camps, and a current configuration parameter of the camera when the electronic device successfully camps on the network, determine whether the antenna is interfered by a signal generated by the camera, obtain a configuration parameter using which the antenna is not interfered when the antenna is interfered by the signal generated by the camera, and modify the current configuration parameter of the camera using the configuration parameter using which the antenna is not interfered to.

In a first possible implementation manner of the third aspect, the electronic device further includes a memory, where the memory is configured to store a preset relational database, where the relational database stores a correspondence between each network resource and each configuration parameter and an interference parameter, and the interference parameter is used to indicate whether the antenna camping on the network resource is interfered by a signal generated by the camera that is started using the configuration parameter. The processor is further configured to determine the interference parameter according to the preset relational database, the obtained network resource, and the obtained current configuration parameter, and determine, according to the interference parameter, whether the antenna is interfered by the signal generated by the camera.

With reference to the third aspect or the first possible implementation manner of the third aspect, in a second possible implementation manner, the processor is further configured to determine, according to the relational database stored in the memory, the configuration parameter using which the antenna camping on the network resource is not interfered.

With reference to the third aspect, the first possible implementation manner of the third aspect, or the second possible implementation manner of the third aspect, in a third possible implementation manner, the processor is further configured to maintain the current configuration parameter unchanged when the antenna is not interfered by the signal generated by the camera.

With reference to the third aspect, the first possible implementation manner of the third aspect, the second possible implementation manner of the third aspect, or the third possible implementation manner of the third aspect, in a fourth possible implementation manner, the processor is further configured to restore the current configuration parameter of the camera to a default configuration parameter when the electronic device does not successfully camp on the network.

With reference to the third aspect, the first possible implementation manner of the third aspect, the second possible implementation manner of the third aspect, the third possible implementation manner of the third aspect, or the fourth possible implementation manner of the third aspect, in a fifth possible implementation manner, the network resource includes the first one, the first two, or all of a frequency band, a channel, and a bandwidth.

According to the method and apparatus for preventing a camera from interfering with an antenna and the electronic device provided in the embodiments of the present disclosure, when a camera is started and an electronic device successfully camps on a network, whether an antenna is interfered by a signal generated by the camera is detected, and if the antenna is interfered by the signal generated by the camera, a configuration parameter using which the antenna is not interfered is configured for the camera. When the antenna is interfered by the camera, a configuration parameter using which the antenna is not interfered may be configured again for the camera. That is, the interference from the camera to the antenna can be eliminated by changing the configuration parameter of the camera in order to resolve the problem that a connector of a camera module leaks some signals, and consequently the antenna performance of the electronic device is affected. Therefore, the interference from the camera to the antenna is eliminated and stability of the antenna performance is improved.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a method flowchart of a method for preventing a camera from interfering with an antenna according to an embodiment of the present disclosure;

FIG. 2 is a method flowchart of a method for preventing a camera from interfering with an antenna according to another embodiment of the present disclosure;

FIG. 3 is a method flowchart of a method for preventing a camera from interfering with an antenna according to still another embodiment of the present disclosure;

FIG. 4 is a schematic structural diagram of an apparatus for preventing a camera from interfering with an antenna according to an embodiment of the present disclosure;

FIG. 5 is a schematic structural diagram of an apparatus for preventing a camera from interfering with an antenna according to another embodiment of the present disclosure;

FIG. 6 is a schematic structural diagram of an electronic device according to an embodiment of the present disclosure; and

FIG. 7 is a schematic structural diagram of an electronic device according to another embodiment of the present disclosure.

### DESCRIPTION OF EMBODIMENTS

To make the objectives, technical solutions, and advantages of the present disclosure clearer, the following further describes the embodiments of the present disclosure in detail with reference to the accompanying drawings.

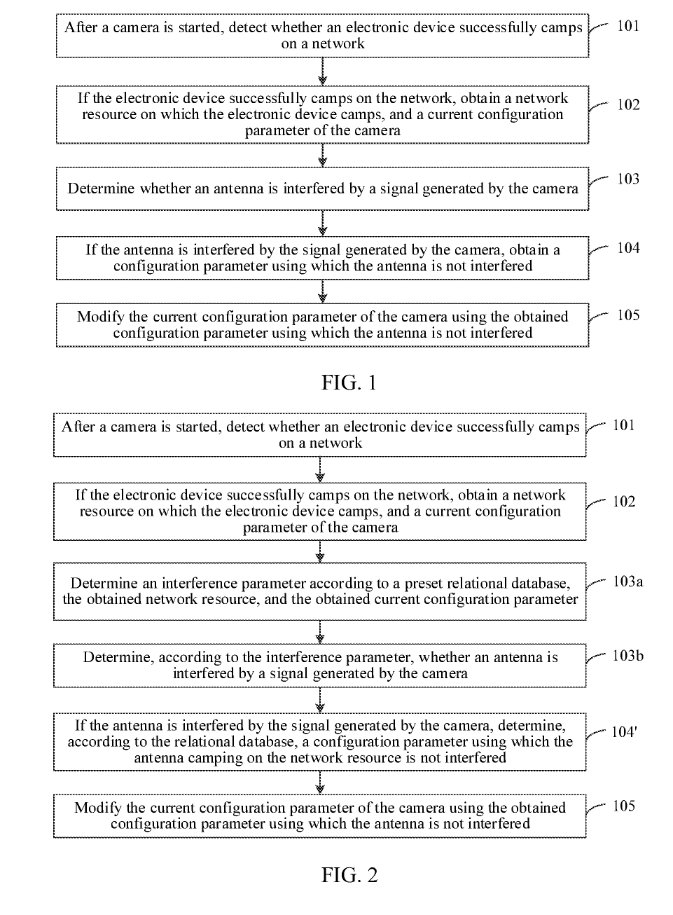

Referring to FIG. 1, FIG. 1 shows a method flowchart of a method for preventing a camera from interfering with an antenna according to an embodiment of the present disclosure. The method for preventing a camera from interfering with an antenna is mainly applied to, for example, an electronic device having a camera and an antenna. The electronic device described herein may be, for example, a smartphone, a tablet computer, a smart television, an electronic book (e-book) reader, a multimedia player, and a portable laptop computer. The method for preventing a camera from interfering with an antenna may include the following steps.

Step 101: After the camera is started, detect whether the electronic device successfully camps on a network.

The successfully camping on the network described herein refers to that the electronic device successfully camps on a digital network, for example, a second generation (2G) mobile communications technology, a third generation (3G) mobile communications technology, a fourth generation (4G) mobile communications technology, or Long Term Evolution (LTE).

Step 102: If the electronic device successfully camps on the network, obtain a network resource on which the electronic device camps, and a current configuration parameter of the camera.

When the electronic device successfully camps on the network, it indicates that the electronic device may have a call and may receive and send a short message service message, or may use the digital network to request a network service, for example, browse a web page, download a network resource, upload a resource, and receive and send an instant messaging message.

In a practical application scenario, when the electronic device successfully camps on the network, the following multiple scenarios are included.

In a scenario, a digital service of the electronic device is turned on and a signal is relatively good. In this case, the electronic device may use the digital network to browse a web page, and may use the digital network to have a call or receive and send a short message service message, and the like.

In another scenario, the digital service of the electronic device is turned off by a user. In this case, the electronic device cannot use the digital network to perform operations such as browse a web page, but may use the digital network to have a call or receive and send a short message service message.

The network resource described herein may include the first one, the first two, or all of a frequency band, a channel, and a bandwidth. That is, the network resource herein may be divided according to a dimension of a frequency band. To implement more detailed division, different channels in the frequency band may be distinguished, to implement finer control. For a variable-bandwidth network, for example, an LTE network, the network resource may be further divided according to a channel and a bandwidth.

A configuration parameter of a camera includes a resolution and a frame rate that are configured for the camera.

Each configuration parameter of the camera affects an antenna camping on some network resources. Therefore, to determine whether the antenna is interfered by a signal generated by the camera, the network resource on which the electronic device camps and the current configuration parameter of the camera need to be obtained.

Step 103: Determine whether the antenna is interfered by a signal generated by the camera.

A signal may be generated after the camera is started, and the signal probably enters the antenna and affects communication of the antenna. Therefore, to prevent the signal generated by the started camera from affecting the antenna, whether the antenna is interfered by the signal generated by the camera needs to be determined.

Step 104: If the antenna is interfered by the signal generated by the camera, obtain a configuration parameter using which the antenna is not interfered.

Step 105: Modify the current configuration parameter of the camera using the obtained configuration parameter using which the antenna is not interfered.

In conclusion, according to the method for preventing a camera from interfering with an antenna provided in this embodiment of the present disclosure, whether an antenna is interfered by a signal generated by the camera is detected when a camera is started and an electronic device successfully camps on a network, and a configuration parameter using which the antenna is not interfered is configured for the camera if the antenna is interfered by the signal generated by the camera. A configuration parameter using which the antenna is not interfered may be configured again for the camera when the antenna is interfered by the camera. That is, interference from the camera to the antenna can be eliminated by changing the configuration parameter of the camera in order to resolve the problem that a connector of a camera module leaks some signals, and consequently the antenna performance of the electronic device is affected. Therefore, interference from the camera to the antenna is eliminated, stability of the antenna performance is improved, and a disadvantage that interference from the camera to the antenna cannot be completely avoided using hardware is overcome.

In an actual application, the electronic device may use a relational database to determine whether the antenna is interfered by the signal generated by the camera. That is, step 103 in FIG. 1 is replaced with step 103a and step 103b in FIG. 2. For details, refer to description of FIG. 2.

Referring to FIG. 2, FIG. 2 shows a method flowchart of a method for preventing a camera from interfering with an antenna according to another embodiment of the present disclosure. The method for preventing a camera from interfering with an antenna is mainly applied to, for example, an electronic device having a camera and an antenna. The electronic device described herein may be, for example, a smartphone, a tablet computer, a smart television, an e-book reader, a multimedia player, and a portable laptop computer. The method for preventing a camera from interfering with an antenna may include the following steps.

Step 101: After the camera is started, detect whether the electronic device successfully camps on a network.

Step 102: If the electronic device successfully camps on the network, obtain a network resource on which the electronic device camps, and a current configuration parameter of the camera.

For both step 101 and step 102, refer to the description of step 101 and step 102 in FIG. 1. Details are not described herein again.

Step 103a: Determine an interference parameter according to a preset relational database, the obtained network resource, and the obtained current configuration parameter.

The relational database described herein stores a correspondence between each network resource and each configuration parameter and an interference parameter. The interference parameter is used to indicate whether the antenna camping on the network resource is interfered by a signal generated by the camera that is started using the configuration parameter.

Generally, each interference parameter in the relational database is used to correspond to one group of a configuration parameter and a network resource. That is, the interference parameter is used to indicate whether a signal generated by a camera configured with the configuration parameter interferes with an antenna camping on the network resource.

For example, refer to the following Table 1. The header of Table 1 includes several configuration parameters. The configuration parameters respectively are a resolution of 1080p and a frame rate of 30 frames per second (fps) (represented by 1080p@30 fps in Table 1), a resolution of 1080p and a frame rate of 15 fps (represented by 1080p@15 fps in Table 1), a resolution of 720p and a frame rate of 30 fps (represented by 720p@30 fps in Table 1), and a resolution of 720p and a frame rate of 15 fps (represented by 720p@15 fps in Table 1). The first column in Table 1 includes several network resources, B1, B2, B3, and the like. In an actual application, the configuration parameter is not limited to the configuration parameters listed in Table 1.

TABLE 1

| | 1080p@30fps | 1080p@15fps | 720p@30fps | 720p@15fps |
|---|---|---|---|---|
| B1 | Y | N | N | N |
| B2 | N | N | Y | N |
| B3 | Y | Y | N | N |
| . . . | . . . | . . . | . . . | . . . |

In Table 1, “Y” indicates that there is interference, and “N” indicates that there is no interference.

For example, Y corresponding to B1 and 1080p@30 fps is used to indicate that a signal generated by the camera configured with 1080p@30 fps interferes with the antenna camping on B1.

For another example, N corresponding to B1 and 1080p@15 fps is used to indicate that a signal generated by the camera configured with 1080p@15 fps does not interfere with the antenna camping on B1.

The electronic device may determine an interference parameter according to the relational database corresponding to the table, the obtained network resource, and the obtained current configuration parameter. For example, when the obtained network resource is 1080p@15 fps, and the current configuration parameter is B3, the electronic device determines that the interference parameter is Y according to the relational database, the network resource, and the current configuration parameter.

Step 103b: Determine, according to the interference parameter, whether the antenna is interfered by a signal generated by the camera.

The interference parameter is used to indicate whether the signal generated by the camera configured with the configuration parameter interferes with the antenna camping on the network resource. Therefore, the electronic device may determine, according to the interference parameter, whether the antenna is interfered by the signal generated by the camera.

For example, when the interference parameter is Y, it indicates that the antenna is interfered by the signal generated by the camera, and when the interference parameter is N, it indicates that the antenna is not interfered by the signal generated by the camera.

If the antenna is interfered by the signal generated by the camera, a configuration parameter using which the antenna is not interfered is obtained. In a possible implementation manner, the electronic device may also use the relational database to obtain the configuration parameter using which the antenna is not interfered. That is, step 104 in FIG. 1 is replaced with step 104′.

Step 104′: If the antenna is interfered by the signal generated by the camera, determine, according to the relational database, a configuration parameter using which the antenna camping on the network resource is not interfered.

Similarly, the relational database is searched for the configuration parameter using which the antenna camping on the network resource is not interfered.

Optionally, if the electronic device finds multiple configuration parameters using which the antenna camping on the network resource is not interfered, the electronic device may randomly select a configuration parameter from the configuration parameters using which there is no interference, select a configuration parameter with a maximum configuration, select a configuration parameter that is superior to the current configuration parameter, select a configuration parameter that is inferior to the current configuration parameter, select a configuration parameter with a minimum configuration from the configuration parameters that are superior to the current configuration parameter, select a configuration parameter with a maximum configuration from the configuration parameters that are inferior to the current configuration parameter, or the like.

Optionally, if the electronic device finds multiple configuration parameters using which the antenna camping on the network resource is not interfered, the configuration parameters using which there is no interference may be displayed to remind a user to select one of the configuration parameters.

Step 105: Modify the current configuration parameters of the camera using the obtained configuration parameters using which the antenna is not interfered.

That is, the current configuration parameter of the camera is replaced with the obtained configuration parameters using which the antenna is not interfered, and a signal generated by the camera no longer interferes with the antenna after replacement.

In conclusion, according to the method for preventing a camera from interfering with an antenna provided in this embodiment of the present disclosure, whether an antenna is interfered by a signal generated by the camera is detected when a camera is started and an electronic device successfully camps on a network, and a configuration parameter using which the antenna is not interfered is configured for the camera if the antenna is interfered by the signal generated by the camera. A configuration parameter using which the antenna is not interfered may be configured again for the camera when the antenna is interfered by the camera. That is, the interference from the camera to the antenna can be eliminated by changing the configuration parameter of the camera in order to resolve the problem that a connector of a camera module leaks some signals, and consequently the antenna performance of the electronic device is affected. Therefore, interference from the camera to the antenna is eliminated, stability of the antenna performance is improved, and a disadvantage that interference from the camera to the antenna cannot be completely avoided using hardware is overcome.

In a possible implementation scenario, if an antenna is not interfered by a signal generated by the camera, the current configuration parameter of the camera may be maintained unchanged to avoid as much as possible interference caused by modification of the configuration parameter.

As long as it is determined each time that the antenna is not interfered by the signal generated by the camera, the current configuration parameter of the camera is maintained unchanged.

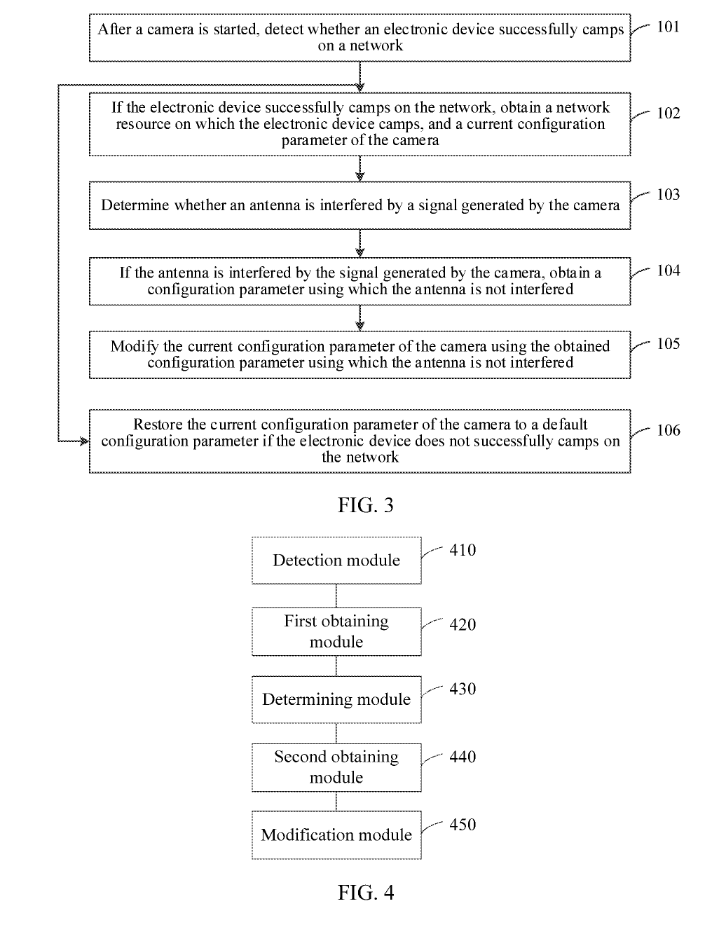

In a possible implementation scenario, referring to FIG. 3, after step 101, the method for preventing a camera from interfering with an antenna may further include the following step.

Step 106: Restore the current configuration parameter of the camera to a default configuration parameter if the electronic device does not successfully camp on the network.

In a practical application scenario, when the electronic device does not successfully camp on the network, the following multiple scenarios are usually included.

In a scenario, the electronic device is in an airplane mode. In this case, the electronic device can neither use a digital network to implement operations such as browse a web page, nor use the digital network to have a call, receive and send a short message service message, or the like.

In another scenario, a signal of a digital network that is received by the electronic device is relatively poor, or the electronic device cannot directly receive a signal of the digital network. In this case, the electronic device is approximately in an airplane mode, that is, the electronic device can neither use the digital network to implement operations such as browse a web page, nor use the digital network to have a call, receive and send a short message service message, or the like.

Therefore, when the electronic device does not successfully camp on the network, the antenna cannot receive or send a signal. In this case, regardless of the configuration parameter of the camera, the antenna is not affected. The current configuration parameter of the camera may be restored to a default configuration parameter such that the configuration parameter of the camera can meet a shooting requirement of a user as much as possible. The default configuration parameter is usually a parameter that is preferentially configured by the user, or a parameter that is preferentially configured by the system for the user and that relatively meets a requirement of the user.

In a possible implementation scenario, after the electronic device configures, for the camera, a configuration parameter using which the antenna is not interfered, the electronic device needs to continue detecting whether the electronic device still camps on the network. When the electronic device does not camp on the network, a corresponding adjustment may be made to better satisfy the shooting requirement of the user. For example, the current configuration parameter of the camera may be restored to the default configuration parameter.

Step 102 to step 105 in FIG. 3 are separately the same as step 102 to step 105 in FIG. 1, and details are not described herein again.

It should be additionally noted that, because the network resource on which the antenna camps may change subsequently, or the antenna may change from a state in which the antenna camps on the network to a state in which the antenna does not camp on the network, after the configuration parameter using which the antenna is not interfered is configured for the camera, it also needs to be detected whether the electronic device successfully camps on a network. If the electronic device no longer successfully camps on a network, step 106 is performed. If the electronic device successfully camps on a network, perform step 102 again. A network resource that is obtained in this case may be different from the network resource obtained previously. That is, the network resource on which the electronic device camps may change. Then, step 103 to step 105 are used to select a configuration parameter using which the antenna camping on the new network resource is not interfered, and the configuration parameter is configured for the camera.

In conclusion, according to the method for preventing a camera from interfering with an antenna, when it is detected that the electronic device changes from a state in which the antenna camps on the network to a state in which the antenna does not camp on the network, a default configuration parameter is configured for the camera again in order to resolve a problem that user shooting experience is relatively poor because the camera still operates using a non-default configuration parameter when the electronic device does not camp on the network. Therefore, user shooting experience and shooting quality are improved.

In addition, a network resource on which the antenna camps is obtained in real time, whether the antenna is interfered by a signal generated by the camera is determined, and a configuration parameter using which the antenna is not interfered is configured for the camera in real time when the antenna is interfered in order to resolve a problem that, in an operating process of the camera, after the network resource of the network on which the electronic device camps changes, the camera interferes with the changed network resource. Therefore, stability of antenna performance is improved.

In a possible implementation scenario, the camera that uses a configuration parameter having a high resolution and a high frame rate can shoot a photo having relatively good definition and fluency, but the shot photo occupies more memory space. Therefore, in a process of obtaining a configuration parameter using which the antenna is not interfered, a suitable configuration parameter may be selected for the user as much as possible such that the camera that uses the configuration parameter can shoot a photo that has relatively good definition and fluency, and that occupies less memory space.

For example, the electronic device sequentially searches, according to a first predetermined sequence, a first pre-stored parameter group for a configuration parameter using which the antenna is not interfered.

The first parameter group includes at least one group of correspondence. The correspondence includes a configuration parameter, a network resource, and an interference parameter. The configuration parameter includes a resolution and a frame rate. The resolution of the correspondence in the first parameter group is higher than or equal to a resolution of the current configuration parameter. The first predetermined sequence is an ascending order of resolutions, or is an ascending order of frame rates when the resolutions are the same.

Optionally, in a processing of obtaining a configuration parameter using which the antenna is not interfered, when the data in the relational database is stored in a form shown in Table 1, for a same network resource, the configuration parameters may be arranged from left to right in descending order of the resolutions to conveniently search for the suitable configuration parameter. When the resolutions are the same, a configuration parameter including a higher frame rate is arranged first, and a configuration parameter including a lower frame rate is arranged subsequently. That is, the resolutions of the configuration parameters in the header of Table 1 are arranged from left to right in descending order, and the frame rates are arranged from left to right in descending order when the resolutions are the same.

For example, referring to Table 1, according to the first predetermined sequence, searching is performed towards left from a currently found interference parameter in Table 1. If an interference parameter used to indicate that there is no interference is found, a first found interference parameter used to indicate that there is no interference is obtained, and a configuration parameter corresponding to the interference parameter is obtained. For example, when the current configuration parameter is 720p@30 fps, and a network resource on which the antenna camps is B2, an obtained interference parameter is Y. A first interference parameter that is found from the interference parameter towards left is N. In this case, a configuration parameter of 1080p@15 fps corresponding to the interference parameter is obtained.

For another example, the electronic device sequentially searches, according to a second predetermined sequence, a second pre-stored parameter group for a configuration parameter using which the antenna is not interfered.

The second parameter group includes at least one group of correspondence. The correspondence includes a configuration parameter, a network resource, and an interference parameter. The configuration parameter includes a resolution and a frame rate. The resolution of the correspondence in the second parameter group is less than or equal to a resolution of the current configuration parameter. The second predetermined sequence is a descending order of resolutions, or is a descending order of frame rates when the resolutions are the same.

Optionally, in a process of obtaining a configuration parameter using which the antenna is not interfered, when the data in the relational database is stored in a form shown in Table 1, for a same network resource, configuration parameters may be arranged from left to right in descending order of the resolutions, to conveniently search for the suitable configuration parameter. When the resolutions are the same, a configuration parameter including a higher frame rate is arranged first, and a configuration parameter including a lower frame rate is arranged subsequently.

For example, referring to Table 1, according to the second predetermined sequence, searching is performed towards right from a currently found interference parameter in Table 1. If an interference parameter used to indicate that there is no interference is found, a first found interference parameter used to indicate that there is no interference is obtained, and a configuration parameter corresponding to the interference parameter is obtained. For example, when the current configuration parameter is 1080p@15 fps, and a network resource on which the antenna camps is B3, an obtained interference parameter is Y. When searching is performed from the interference parameter towards left and an interference parameter used to indicate that there is no interference is not found, continue to perform searching towards right, a first found interference parameter used to indicate that there is no interference is obtained, and a configuration parameter of 720p@30 fps corresponding to the interference parameter is obtained.

Referring to FIG. 4, FIG. 4 shows a schematic structural diagram of an apparatus for preventing a camera from interfering with an antenna according to an embodiment of the present disclosure. The apparatus for preventing a camera from interfering with an antenna is mainly applied to, for example, an electronic device having a camera and an antenna. The electronic device described herein may be, for example, a smartphone, a tablet computer, a smart television, an e-book reader, a multimedia player, and a portable laptop computer. The apparatus for preventing a camera from interfering with an antenna may include a detection module 410, a first obtaining module 420, a determining module 430, a second obtaining module 440, and a modification module 450.

The detection module 410 is configured to detect whether the electronic device successfully camps on a network after the camera is started.

The first obtaining module 420 is configured to obtain a network resource on which the electronic device camps, and a current configuration parameter of the camera when the detection module 410 detects that the electronic device successfully camps on the network.

The determining module 430 is configured to determine whether the antenna is interfered by a signal generated by the camera.

The second obtaining module 440 is configured to obtain a configuration parameter using which the antenna is not interfered when the determining module 430 determines that the antenna is interfered by the signal generated by the camera.

The modification module 450 is configured to modify the current configuration parameter of the camera that is obtained by the first obtaining module 420, using the configuration parameter using which the antenna is not interfered and that is obtained by the second obtaining module 440.

In conclusion, according to the apparatus for preventing a camera from interfering with an antenna provided in this embodiment of the present disclosure, whether an antenna is interfered by a signal generated by the camera is detected when a camera is started and an electronic device successfully camps on a network, and a configuration parameter using which the antenna is not interfered is configured for the camera if the antenna is interfered by the signal generated by the camera. A configuration parameter using which the antenna is not interfered may be configured again for the camera when the antenna is interfered by the camera. That is, the interference from the camera to the antenna can be eliminated by changing the configuration parameter of the camera in order to resolve the problem that a connector of a camera module leaks some signals, and consequently the antenna performance of the electronic device is affected. Therefore, interference from the camera to the antenna is eliminated, stability of the antenna performance is improved, and a disadvantage that interference from the camera to the antenna cannot be completely avoided using hardware is overcome.

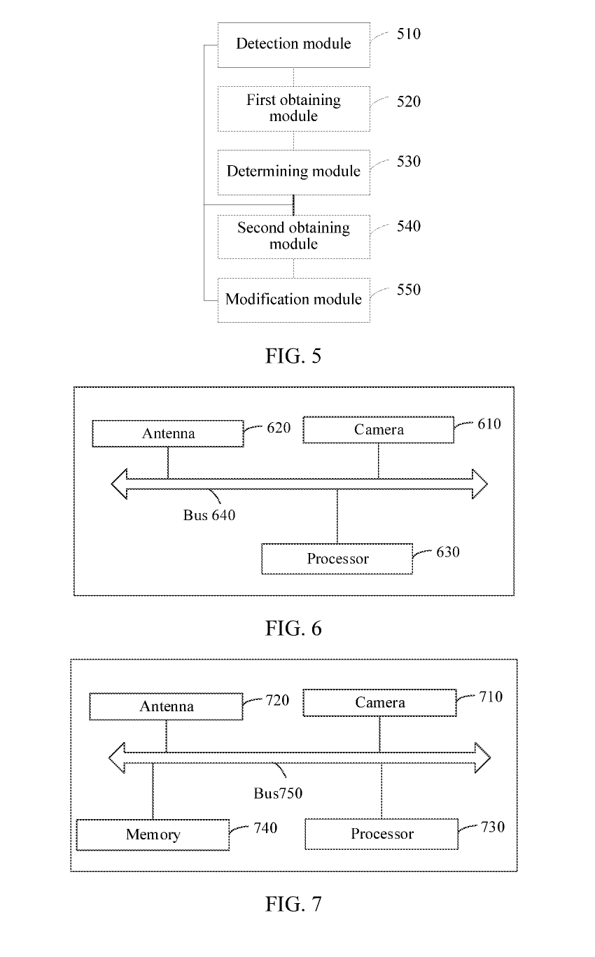

Referring to FIG. 5, FIG. 5 shows a schematic structural diagram of an apparatus for preventing a camera from interfering with an antenna according to another embodiment of the present disclosure. The apparatus for preventing a camera from interfering with an antenna is mainly applied to, for example, an electronic device having a camera and an antenna. The electronic device described herein may be, for example, a smartphone, a tablet computer, a smart television, an e-book reader, a multimedia player, and a portable laptop computer. The apparatus for preventing a camera from interfering with an antenna may include a detection module 510, a first obtaining module 520, a determining module 530, a second obtaining module 540, and a modification module 550.

The detection module 510 is configured to detect whether the electronic device successfully camps on a network after the camera is started.

The first obtaining module 520 is configured to obtain a network resource on which the electronic device camps, and a current configuration parameter of the camera when the detection module 510 detects that the electronic device successfully camps on the network.

The determining module 530 is configured to determine whether the antenna is interfered by a signal generated by the camera.

The second obtaining module 540 is configured to obtain a configuration parameter using which the antenna is not interfered when the determining module 530 determines that the antenna is interfered by the signal generated by the camera.

The modification module 550 is configured to modify the current configuration parameter of the camera that is obtained by the first obtaining module 520, using the configuration parameter using which the antenna is not interfered and that is obtained by the second obtaining module 540.

In a possible implementation manner, the determining module 530 is further configured to determine an interference parameter according to a preset relational database, the obtained network resource, and the obtained current configuration parameter, where the relational database stores a correspondence between each network resource and each configuration parameter and an interference parameter, and the interference parameter is used to indicate whether an antenna camping on the network resource is interfered by a signal generated by the camera that is started using the configuration parameter, and determine, according to the interference parameter, whether the antenna is interfered by the signal generated by the camera.

In a possible implementation manner, the second obtaining module 540 is further configured to determine, according to the relational database, the configuration parameter using which the antenna camping on the network resource is not interfered.

In a possible implementation manner, the modification module 550 is further configured to maintain the current configuration parameter unchanged when the determining module 530 determines that the antenna is not interfered by the signal generated by the camera.

In a possible implementation manner, the modification module 550 is further configured to restore the current configuration parameter of the camera to a default configuration parameter when the detection module 510 detects that the electronic device does not successfully camp on the network.

In a possible implementation manner, the network resource includes the first one, the first two, or all of a frequency band, a channel, and a bandwidth.

In conclusion, according to the apparatus for preventing a camera from interfering with an antenna provided in this embodiment of the present disclosure, whether an antenna is interfered by a signal generated by the camera is detected when a camera is started and an electronic device successfully camps on a network, and a configuration parameter using which the antenna is not interfered is configured for the camera if the antenna is interfered by the signal generated by the camera. A configuration parameter using which the antenna is not interfered may be configured again for the camera when the antenna is interfered by the camera. That is, the interference from the camera to the antenna can be eliminated by changing the configuration parameter of the camera in order to resolve the problem that a connector of a camera module leaks some signals, and consequently the antenna performance of the electronic device is affected. Therefore, interference from the camera to the antenna is eliminated, stability of the antenna performance is improved, and a disadvantage that interference from the camera to the antenna cannot be completely avoided using hardware is overcome.

In addition, when it is detected that the electronic device changes from a state in which the antenna camps on the network to a state in which the antenna does not camp on the network, a default configuration parameter is configured for the camera again in order to resolve a problem that user shooting experience is relatively poor because the camera still operates using a non-default configuration parameter when the electronic device does not camp on the network. Therefore, user shooting experience and shooting quality are improved.

In addition, a network resource on which the antenna camps is obtained in real time, whether the antenna is interfered by a signal generated by the camera is determined, and a configuration parameter using which the antenna is not interfered is configured for the camera in real time when the antenna is interfered in order to resolve a problem that, in an operating process of the camera, after the network resource of the network on which the electronic device camps changes, the camera interferes with the changed network resource. Therefore, stability of antenna performance is improved.

It should be noted that, when the apparatus for preventing a camera from interfering with an antenna provided in the foregoing embodiment prevents the camera from interfering with the antenna, division of the functional modules is merely used as an example for description. In a practical application, the functions may be allocated to and implemented by different functional modules according to needs. That is, an internal structure of an electronic device is divided into different functional modules to implement all or some of the functions described above. In addition, the apparatus for preventing a camera from interfering with an antenna and the method for preventing a camera from interfering with an antenna provided in the foregoing embodiments belong to a same concept. For a specific implementation process thereof, refer to the embodiments of the method, and details are not described herein again.

Referring to FIG. 6, FIG. 6 shows a schematic structural diagram of an electronic device according to an embodiment of the present disclosure. The electronic device may include a camera 610, an antenna 620, and a processor 630, where the camera 610 and the antenna 620 are separately connected to the processor 630 using a bus 640.

The processor 630 is configured to detect whether the electronic device successfully camps on a network after the camera 610 is started.

The processor 630 is further configured to obtain a network resource on which the electronic device camps, and a current configuration parameter of the camera 610 when the electronic device successfully camps on the network.

The processor 630 is further configured to determine whether the antenna 620 is interfered by a signal generated by the camera 610.

The processor 630 is further configured to obtain a configuration parameter using which the antenna 620 is not interfered when the antenna 620 is interfered by the signal generated by the camera 610.

The processor 630 is further configured to modify the current configuration parameter of the camera 610 using the configuration parameter using which the antenna 620 is not interfered.

In conclusion, according to the electronic device provided in this embodiment of the present disclosure, when the camera 610 is started and an electronic device successfully camps on a network, whether the antenna 620 is interfered by a signal generated by the camera 610 is detected, and if the antenna 620 is interfered by the signal generated by the camera 610, a configuration parameter using which the antenna 620 is not interfered is configured for the camera 610. When the antenna 620 is interfered by the camera 610, a configuration parameter using which the antenna 620 is not interfered may be configured again for the camera 610. That is, the interference from the camera 620 to the antenna can be eliminated by changing the configuration parameter of the camera 610 in order to resolve the problem that a connector of a camera module leaks some signals, and consequently the antenna 620 performance of the electronic device is affected. Therefore, interference from the camera 610 to the antenna 620 is eliminated, stability of the antenna 620 performance is improved, and a disadvantage that interference from the camera 610 to the antenna 620 cannot be completely avoided using hardware is overcome.

Referring to FIG. 7, FIG. 7 shows a schematic structural diagram of an electronic device according to another embodiment of the present disclosure. The electronic device may include a camera 710, an antenna 720, and a processor 730, where the camera 710 and the antenna 720 are separately connected to the processor 730 using a bus 750. The processor 730 performs the following operations.

The processor 730 is configured to detect whether the electronic device successfully camps on a network after the camera 710 is started.

The processor 730 is further configured to obtain a network resource on which the electronic device camps, and a current configuration parameter of the camera 710 when the electronic device successfully camps on the network.

The processor 730 is further configured to determine whether the antenna 720 is interfered by a signal generated by the camera 710.

The processor 730 is further configured to obtain a configuration parameter using which the antenna 720 is not interfered when the antenna 720 is interfered by the signal generated by the camera 710.

The processor 730 is further configured to modify the current configuration parameter of the camera 710 using the configuration parameter using which the antenna 720 is not interfered.

In a possible implementation manner, the electronic device further includes a memory 740, where the memory 740 is connected to the processor 730 using the bus 750.

The memory 740 is configured to store a preset relational database, where the relational database stores a correspondence between each network resource and each configuration parameter and an interference parameter, and the interference parameter is used to indicate whether the antenna 720 camping on the network resource is interfered by a signal generated by the camera 710 that is started using the configuration parameter.

The processor 730 is further configured to determine the interference parameter according to the preset relational database, the obtained network resource, and the obtained current configuration parameter.

The processor 730 is further configured to determine, according to the interference parameter, whether the antenna 720 is interfered by the signal generated by the camera 710.

In a possible implementation manner, the processor 730 is further configured to determine, according to the relational database stored in the memory 740, the configuration parameter using which the antenna 720 camping on the network resource is not interfered.

In a possible implementation manner, the processor 730 is further configured to maintain the current configuration parameter unchanged when the antenna 720 is not interfered by the signal generated by the camera 710.

In a possible implementation manner, the processor 730 is further configured to restore the current configuration parameter of the camera 710 to a default configuration parameter when the electronic device does not successfully camp on the network.

In a possible implementation manner, the network resource includes the first one, the first two, or all of a frequency band, a channel, and a bandwidth.

In conclusion, according to the electronic device provided in this embodiment of the present disclosure, when the camera 710 is started and an electronic device successfully camps on the network, whether the antenna 720 is interfered by a signal generated by the camera 710 is detected, and if the antenna 720 is interfered by the signal generated by the camera 710, a configuration parameter using which the antenna 720 is not interfered is configured for the camera 710. When the antenna 720 is interfered by the camera 710, a configuration parameter using which the antenna is not interfered may be configured again for the camera 710. That is, the interference from the camera 710 to the antenna 720 can be eliminated by changing the configuration parameter of the camera 710 in order to resolve the problem that a connector of a camera module leaks some signals, and consequently the antenna 720 performance of the electronic device is affected. Therefore, interference from the camera 710 to the antenna is eliminated, stability of the antenna 720 performance is improved, and a disadvantage that interference from the camera 710 to the antenna 720 cannot be completely avoided using hardware is overcome.

In addition, when it is detected that the electronic device changes from a state in which the antenna 720 camps on the network to a state in which the antenna 720 does not camp on the network, a default configuration parameter is configured for the camera 710 again in order to resolve a problem that user shooting experience is relatively poor because the camera 710 still operates using a non-default configuration parameter when the electronic device does not camp on the network. Therefore, user shooting experience and shooting quality are improved.

In addition, a network resource on which the antenna 720 camps is obtained in real time, whether the antenna 720 is interfered by a signal generated by the camera 710 is determined, and a configuration parameter using which the antenna 720 is not interfered is configured for the camera 710 in real time when the antenna 720 is interfered in order to resolve a problem that, in an operating process of the camera 710, after the network resource of the network on which the electronic device camps changes, the camera 710 interferes with the changed network resource. Therefore, stability of antenna 720 performance is improved.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present disclosure.

It may be clearly understood by a person skilled in the art that, for the purpose of convenient and brief description, for a detailed working process of the foregoing apparatus and unit, refer to a corresponding process in the foregoing method embodiments, and details are not described herein again.

In the several embodiments provided in the present application, it should be understood that the disclosed apparatus and method may be implemented in other manners. For example, the described apparatus embodiment is merely an example. For example, the unit division may merely be logical function division and may be other division in actual implementation. For example, a plurality of units or components may be combined or integrated into another system, or some features may be ignored or not performed. In addition, the displayed or discussed mutual couplings or direct couplings or communication connections may be implemented using some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present disclosure essentially, or the part contributing to the other approaches, or some of the technical solutions may be implemented in a form of a software product. The software product is stored in a storage medium, and includes several instructions for instructing a computer device (which may be a personal computer, a server, or a network device) to perform all or some of the steps of the methods described in the embodiments of the present disclosure. The foregoing storage medium includes any medium that can store program code, such as a universal serial bus (USB) flash drive, a removable hard disk, a read-only memory (ROM), a random access memory (RAM), a magnetic disk, or an optical disc.

The foregoing descriptions are merely specific implementation manners of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1.-18. (canceled)

19. A method for preventing a camera from interfering with an antenna, applied to an electronic device comprising the camera and the antenna, wherein the method comprises:
detecting whether the electronic device successfully camps on a network after the camera is started;
obtaining a network resource on which the electronic device camps and a current configuration parameter of the camera when the electronic device successfully camps on the network;
determining whether the antenna is interfered with by a signal generated by the camera;
obtaining a configuration parameter using an antenna which is not interfered with when the antenna is interfered with by the signal generated by the camera; and
modifying the current configuration parameter of the camera using the obtained configuration parameter using the antenna which is not interfered with.

20. The method according to claim 19, wherein determining whether the antenna is interfered with by the signal generated by the camera comprises:
determining an interference parameter according to a preset relational database, the obtained network resource, and the obtained current configuration parameter, wherein the preset relational database stores a correspondence between each network resource and each configuration parameter and an interference parameter, and wherein the interference parameter indicates whether the antenna camping on the network resource is interfered with by the signal generated by the camera that is started using the configuration parameter; and
determining, according to the interference parameter, whether the antenna is interfered with by the signal generated by the camera.

21. The method according to claim 20, wherein obtaining the configuration parameter using the antenna which is not interfered with comprises determining, according to the preset relational database, the configuration parameter using the antenna camping on the network resource which is not interfered with.

22. The method according to claim 19, further comprising maintaining the current configuration parameter unchanged when the antenna which is not interfered with by the signal generated by the camera.

23. The method according to claim 20, further comprising maintaining the current configuration parameter unchanged when the antenna which is not interfered with by the signal generated by the camera.

24. The method according to claim 21, further comprising maintaining the current configuration parameter unchanged when the antenna is not interfered with by the signal generated by the camera.

25. The method according to claim 19, further comprising restoring the current configuration parameter of the camera to a default configuration parameter when the electronic device does not successfully camp on the network.

26. The method according to claim 20, further comprising restoring the current configuration parameter of the camera to a default configuration parameter when the electronic device does not successfully camp on the network.

27. The method according to claim 19, wherein the network resource comprises at least one of a frequency band, a channel, and a bandwidth.

28. The method according to claim 20, wherein the network resource comprises at least one of a frequency band, a channel, and a bandwidth.

29. An electronic device, comprising:
a camera;
an antenna; and
a processor,
wherein the camera, the antenna, and the processor coupled to each other using a bus, and
wherein the processor is configured to:
detect whether the electronic device successfully camps on a network after the camera is started;
obtain a network resource on which the electronic device camps and a current configuration parameter of the camera when the electronic device successfully camps on the network;
determine whether the antenna is interfered with by a signal generated by the camera;
obtain a configuration parameter using an antenna which is not interfered with when the antenna is interfered with by the signal generated by the camera; and
modify the current configuration parameter of the camera using the configuration parameter using the antenna which is not interfered with.

30. The electronic device according to claim 29, further comprising a memory coupled to the processor using the bus, wherein the memory is configured to store a preset relational database, wherein the preset relational database is configured to store a correspondence between each network resource and each configuration parameter and an interference parameter, wherein the interference parameter indicates whether the antenna camping on the network resource is interfered with by the signal generated by the camera that is started using the configuration parameter, and wherein the processor is further configured to:
determine the interference parameter according to the preset relational database, the obtained network resource, and the obtained current configuration parameter; and
determine, according to the interference parameter, whether the antenna is interfered with by the signal generated by the camera.

31. The electronic device according to claim 30, wherein the processor is further configured to determine, according to the preset relational database stored in the memory, the configuration parameter using the antenna camping on the network resource which is not interfered with.

32. The electronic device according to claim 29, wherein the processor is further configured to maintain the current configuration parameter unchanged when the antenna is not interfered with by the signal generated by the camera.

33. The electronic device according to claim 30, wherein the processor is further configured to maintain the current configuration parameter unchanged when the antenna is not interfered with by the signal generated by the camera.

34. The electronic device according to claim 31, wherein the processor is further configured to maintain the current configuration parameter unchanged when the antenna is not interfered with by the signal generated by the camera.

35. The electronic device according to claim 29, wherein the processor is further configured to restore the current configuration parameter of the camera to a default configuration parameter when the electronic device does not successfully camp on the network.

36. The electronic device according to claim 30, wherein the processor is further configured to restore the current configuration parameter of the camera to a default configuration parameter when the electronic device does not successfully camp on the network.

37. The electronic device according to claim 29, wherein the network resource comprises at least one of a frequency band, a channel, and a bandwidth.

38. The electronic device according to claim 30, wherein the network resource comprises at least one of a frequency band, a channel, and a bandwidth.
